(19) United States
(12) Patent Application Publication
(10) Pub. No.: US 2024/0208353 A1
(43) Pub. Date: Jun. 27, 2024

(54) ELECTRIC VEHICLE CHARGING MANAGEMENT AND CLIENT DEVICE

(71) Applicant: Liikennevirta Oy / Virta Ltd, Helsinki (FI)

(72) Inventor: Jussi AHTIKARI, Helsinki (FI)

(73) Assignee: Liikennevirta Oy / Virta Ltd, Helsinki (FI)

(21) Appl. No.: 18/289,029

(22) PCT Filed: Jun. 22, 2022
(86) PCT No.: PCT/FI2022/050454

§ 371 Date: Oct. 31, 2023

(30) Foreign Application Priority Data
Jun. 28, 2021 (FI) 20215764

(51) Int. Cl. B60L 53/62; B60L 53/30; B60L 53/68; H02J 7/00

(52) U.S. Cl. CPC B60L 53/62; B60L 53/305; B60L 53/68; H02J 7/00045; B60L 2250/20

(57) ABSTRACT

According to an embodiment, a client device is configured to in response to an input from a user of the client device, wherein the input indicates that the user wishes to charge an electric vehicle, EV, using an EV charging station, transmit a request for EV charging using the EV charging station to a primary EV charging management system, wherein the request for EV charging using the EV charging station comprises an identification of the EV charging station; and in response to the primary EV charging management system not responding to the request for EV charging using the EV charging station, transmit the request for EV charging using the EV charging station to a backup EV charging management system.

### TECHNICAL FIELD

The present disclosure relates to electric vehicle charging, and more particularly to a client device, an electric vehicle charging management backup device, and corresponding methods and computer program products.

### BACKGROUND

Electric vehicle (EV) charging stations are typically managed by a management system, such as a charging point management system (CPMS). A CPMS can handle different operations related to EV charging. For example, end users may use mobile devices, such as phones, to start and stop charging on EV charging stations. Typically, mobile apps connect to an application programming interface (API) of the CPMS which then processes the requests and passes the commands to the EV charging stations. Usually CPMSs have quite a complicated technical architecture and logic. In order for the CPMS to give a valid reply to a request by an EV charging station, all the technical components may need to be functioning properly. However, no technology is perfect, and sometimes CPMS systems have technical issues. When this occurs, it is quite common for customers to not be able to charge their vehicles using the EV charging stations until issues with the CPMS have been resolved.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

It is an object to provide a backup electric vehicle charging management device and a corresponding method. The foregoing and other objects are achieved by the features of the independent claims. Further implementation forms are apparent from the dependent claims, the description and the figures.

According to a first aspect a client device comprises at least one processor and at least one memory including computer program code, the at least one memory and the computer program code being configured to, with the at least one processor, cause the client device to: in response to an input from a user of the client device, wherein the input indicates that the user wishes to charge an electric vehicle, EV, using an EV charging station, transmit a request for EV charging using the EV charging station to a primary EV charging management system, wherein the request for EV charging using the EV charging station comprises an identification of the EV charging station; and in response to the primary EV charging management system not responding to the request for EV charging using the EV charging station, transmit the request for EV charging using the EV charging station to a backup EV charging management system. The client device can, for example, efficiently switch from communicating with the primary system to communicating with the secondary system so that the user can seamlessly use the EV charging station even when the primary system is unavailable.

In another implementation form of the first aspect, the client device is preconfigured with an application programming interface, API, uniform resource locator, URL, for the primary EV charging management system and an API URL for the backup EV charging management system, and the at least one memory and the computer program code are further configured to, with the at least one processor, cause the client device to transmit the request for EV charging using the EV charging station to the primary EV charging management system based on the API URL of primary the EV charging management system and to transmit the request the request for EV charging using the EV charging station to the backup EV charging management system based on the API URL of the backup EV charging management system. The client device can, for example, efficiently communicate with the primary system and the secondary system using the API URLs.

In another implementation form of the first aspect, the request for EV charging using the EV charging station further comprises: an indication of an electrical connector of the EV charging station the user wishes to use for the charging; and/or an identification of the user. The client device can, for example, provide the identification of the user to secondary system so that the secondary system can authenticate the user.

In another implementation form of the first aspect, the identification of the user comprises an identity token of the user. The client device can, for example, efficiently provide the identification of the user to secondary system using the identity token so that the secondary system can authenticate the user.

In another implementation form of the first aspect, the at least one memory and the computer program code are further configured to, with the at least one processor, cause the client device to, in response to the primary EV charging management system not responding to the request for EV charging using the EV charging station, transition into a fault mode, and when in the fault mode, in response to a further input from a user of the client device, wherein the further input indicates that the user wishes to stop the EV charging using an EV charging station, transmit a request to stop the EV charging using the EV charging station to the backup EV charging management system. The client device can, for example, stop the charging using the EV charging station even when the primary system is unavailable.

In another implementation form of the first aspect, the at least one memory and the computer program code are further configured to, with the at least one processor, cause the client device, when in the fault mode, to periodically check whether the primary EV charging management system is available. The client device can, for example, switch back to communicating with the primary system when the primary system is again available.

According to a second aspect, a backup electric vehicle, EV, charging management device comprises at least one processor and at least one memory including computer program code, the at least one memory and the computer program code being configured to, with the at least one processor, cause the backup EV charging management device to: when a primary EV charging management system is available, synchronize a data storage of a backup EV charging management system with a data storage of the primary EV charging management system, wherein the data storage of the primary EV charging management system comprises identifications of a plurality of EV charging stations; when the primary EV charging management system is unavailable, receive a request for charging using a target EV charging station from a client device, wherein the request comprises an identification of the target EV charging station; check whether the request should be allowed by comparing the identification of the target EV charging station and the identifications of a plurality of EV charging stations in the data storage of the backup EV charging management system; and in response to determining that the request should be allowed, transmit an acceptance message, indicating to accept the use of the target EV charging station, to the target EV charging station. The backup EV charging management device can, for example, enable the user to charge using the target EV charging station even when the primary system is unavailable.

In an implementation form of the second aspect, the data storage of the primary EV management system further comprises information about available connectors in each EV charging station in the plurality of EV charging station and wherein the request further comprises an indication of a connector the user wishes to use in the target EV charging station, and wherein the at least one memory and the computer program code are further configured to, with the at least one processor, cause the backup EV charging management device to: check whether the request should be allowed by comparing the indication of a connector the user wishes to use and information about available connectors in each EV charging station in the plurality of EV charging station in the data storage of the backup EV charging management system. The backup EV charging management device can, for example, enable the user to charge using a specific connector of the target EV charging station even when the primary system is unavailable.

In another implementation form of the second aspect, the data storage of the primary EV management system further comprises a plurality of user identifications and wherein the request further comprises a user identification, and wherein the at least one memory and the computer program code are further configured to, with the at least one processor, cause the backup EV charging management device to: check whether the request should be allowed by comparing the user identification in the request to the plurality of user identifications in the data storage of the backup EV charging management system. The backup EV charging management device can, for example, authenticate the user even when the primary system is unavailable.

In another implementation form of the second aspect, the data storage of the primary EV management system further comprises identifications of ongoing charging events and wherein the at least one memory and the computer program code are further configured to, with the at least one processor, cause the backup EV charging management device to: in response to receiving a request to stop charging comprising a charging event identification, check whether the request to stop charging should be allowed by comparing the identification in the request to the identifications of ongoing charging events in the data storage of the backup EV charging management system; and in response to determining that the request to stop charging should be allowed, send a charging event stop command to an EV charging station corresponding to the charging event identification in the request. The backup EV charging management device can, for example, stop charging events that have started when the primary system was available.

In another implementation form of the second aspect, the at least one memory and the computer program code are further configured to, with the at least one processor, cause the backup EV charging management device to: when the primary EV charging management system is unavailable, store information about charging events into the data storage of the backup EV management system; and in response to the primary EV charging management system becoming available, provide the stored information about the charging events to the primary EV charging management system. The backup EV charging management device can, for example, save the information about the charging events so that no such information is lost even when the primary system is unavailable.

In another implementation form of the second aspect, the information about charging events comprises at least one of: indication that a charging event that started when the primary EV management system was available, ended when the primary EV management system was unavailable; indication that a new charging event has started when the primary EV charging management system was unavailable and is ongoing when the primary EV charging management system is again available; and/or indication that a new charging event has started and ended when the primary EV charging management system was unavailable. The backup EV charging management device can, for example, save the indications about the charging events so that no such information is lost even when the primary system is unavailable.

According to third aspect, a method comprises: in response to an input from a user of a client device, wherein the input indicates that the user wishes to charge an electric vehicle, EV, using an EV charging station, transmitting a request for EV charging using the EV charging station to a primary EV charging management system, wherein the request for EV charging using the EV charging station comprises an identification of the EV charging station; and in response to the primary EV charging management system not responding to the request for EV charging using the EV charging station, transmitting the request for EV charging using the EV charging station to a backup EV charging management system.

According to fourth aspect, a method comprises: when a primary electric vehicle, EV, charging management system is available, synchronizing a data storage of a backup EV charging management system with a data storage of the primary EV charging management system, wherein the data storage of the primary EV charging management system comprises identifications of a plurality of EV charging stations; when the primary EV charging management system is unavailable, receiving a request for charging using a target EV charging station from a client device, wherein the request comprises an identification of the target EV charging station; checking whether the request should be allowed by comparing the identification of the target EV charging station and the identifications of a plurality of EV charging stations in the data storage of the backup EV charging management system; and in response to determining that the request should be allowed, transmitting an acceptance message, indicating to accept the use of the target EV charging station, to the target EV charging station.

According to fifth aspect, a computer program product is provided, comprising program code configured to perform a method according to the third or the fourth aspect when the computer program is executed on a computer.

Many of the attendant features will be more readily appreciated as they become better understood by reference to the following detailed description considered in connection with the accompanying drawings.

### DESCRIPTION OF THE DRAWINGS

In the following, embodiments are described in more detail with reference to the attached figures and drawings, in which:

FIG. 1 illustrates a client device according to an embodiment;

FIG. 2 illustrates a schematic representation of an electric vehicle charging system according to an example;

FIG. 3 illustrates a backup electric vehicle charging management device according to an embodiment;

FIG. 4 illustrates a schematic representation of an electric vehicle charging system according to an embodiment;

FIG. 5 illustrates a schematic representation of a user interface of a client device according to an embodiment;

FIG. 6 illustrates a schematic representation of functionality of the electric vehicle charging system when the primary system is available according to an embodiment;

FIG. 7 illustrates a schematic representation of functionality of the electric vehicle charging system when the primary system is unavailable according to an embodiment;

FIG. 8 illustrates a schematic representation of functionality of the electric vehicle charging system when the primary system is again available after being unavailable according to an embodiment;

FIG. 9 illustrates a flow chart representation of a client mode switching procedure according to an embodiment;

FIG. 10 illustrates a schematic representation of a data storage structure according to an embodiment;

FIG. 11 illustrates a flow chart representation of a data offloading procedure according to an embodiment;

FIG. 12 illustrates a schematic representation of a method according to an embodiment; and

FIG. 13 illustrates a schematic representation of a method according to another embodiment.

In the following, like reference numerals are used to designate like parts in the accompanying drawings.

### DETAILED DESCRIPTION

In the following description, reference is made to the accompanying drawings, which form part of the disclosure, and in which are shown, by way of illustration, specific aspects in which the present disclosure may be placed. It is understood that other aspects may be utilized, and structural or logical changes may be made without departing from the scope of the present disclosure. The following detailed description, therefore, is not to be taken in a limiting sense, as the scope of the present disclosure is defined be the appended claims.

For instance, it is understood that a disclosure in connection with a described method may also hold true for a corresponding device or system configured to perform the method and vice versa. For example, if a specific method step is described, a corresponding device may include a unit to perform the described method step, even if such unit is not explicitly described or illustrated in the figures. On the other hand, for example, if a specific apparatus is described based on functional units, a corresponding method may include a step performing the described functionality, even if such step is not explicitly described or illustrated in the figures. Further, it is understood that the features of the various example aspects described herein may be combined with each other, unless specifically noted otherwise.

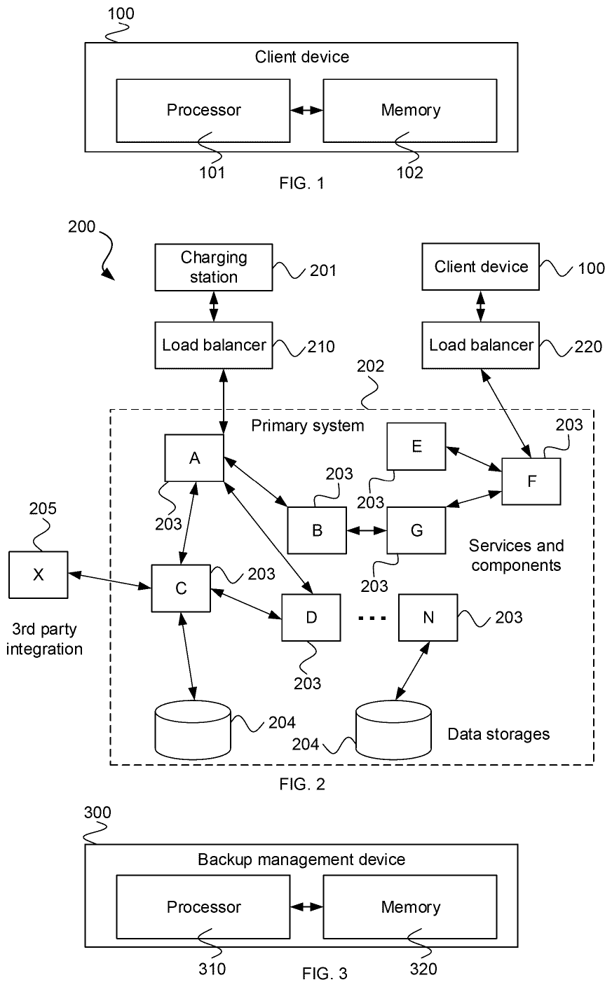

FIG. 1 illustrates a client device according to an embodiment.

According to an embodiment, a client device 100 comprises at least one processor 101 and at least one memory 102 including computer program code.

According to an embodiment, the at least one memory 102 and the computer program code configured to, with the at least one processor 101, cause the client device 100 to, in response to an input from a user of the client device, wherein the input indicates that the user wishes to charge an electric vehicle, EV, using an EV charging station, transmit a request for EV charging using the EV charging station to a primary EV charging management system, wherein the request for EV charging using the EV charging station comprises an identification of the EV charging station.

Herein, the primary EV charging management system may be referred to simply as the primary system or similar.

The client device 100 may correspond to any device, such as a mobile device, used by a user. For example, the client device 100 may comprise a mobile phone, a smart phone, a laptop computer, a tablet computer, or similar.

The client device 100 may, for example, execute a mobile application (app) via which the user of the client device 100 can interact with the client device 100, request for EV charging, and perform actions related to EV charging.

The client device 100 may be further configured to, in response to the primary EV charging management system not responding to the request for EV charging using the EV charging station, transmit the request for EV charging using the EV charging station to a backup EV charging management system.

Herein, the backup EV charging management system may be referred to simply as the backup system or similar.

The primary EV charging management system may be “unavailable” any time that the client device 100 and/or other devices/components/systems cannot reach the primary EV charging management system. For example, a communication link between the client device 100 and the primary EV charging management system may be malfunctioning, the primary EV charging management system or some part of it may be malfunctioning, and/or the primary EV charging management system may be offline for maintenance or similar purposes.

The client device 100 may comprise at least one processor 101. The at least one processor 101 may comprise, for example, one or more of various processing devices, such as a co-processor, a microprocessor, a controller, a digital signal processor (DSP), a processing circuitry with or without an accompanying DSP, or various other processing devices including integrated circuits such as, for example, an application specific integrated circuit (ASIC), a field programmable gate array (FPGA), a microcontroller unit (MCU), a hardware accelerator, a special-purpose computer chip, or the like.

The client device 100 may further comprise a memory 102. The memory 102 may be configured to store, for example, computer programs and the like. The memory 102 may comprise one or more volatile memory devices, one or more non-volatile memory devices, and/or a combination of one or more volatile memory devices and nonvolatile memory devices. For example, the memory 102 may be embodied as magnetic storage devices (such as hard disk drives, floppy disks, magnetic tapes, etc.), optical magnetic storage devices, and semiconductor memories (such as mask ROM, PROM (programmable ROM), EPROM (erasable PROM), flash ROM, RAM (random access memory), etc.).

When the client device 100 is configured to implement some functionality, some component and/or components of the client device 100, such as the at least one processor 101 and/or the memory 102, may be configured to implement this functionality. Furthermore, when the at least one processor 101 is configured to implement some functionality, this functionality may be implemented using program code comprised, for example, in the memory 102. For example, if the client device 100 is configured to perform an operation, the at least one memory 102 and the computer program code can be configured to, with the at least one processor 101, cause the client device 100 to perform that operation.

FIG. 2 illustrates a schematic representation of an EV charging system 200 according to an example.

The EV charging system 200 may comprise one or more EV charging stations (CS) 201 that are connected to a primary EV charging management system 202. The system 200 may further comprise a first load balancer 210. The first load balancer 210 may forward messages from the one or more EV charging stations 201 to the primary EV charging management system 202 when the primary EV charging management system 202 is available. The first load balancer 210 may also forward messages from the primary EV charging management system 202 to the one or more EV charging stations 201 when the primary EV charging management system 202 is available. The first load balancer 210 may, for example, implement an application programming interface (API) using which the one or more EV charging stations 201 can communicate with the primary system 202.

The primary EV charging management system 202 may comprise, for example, a charging point management system (CPMS). The primary system 202 can handle different operations related to EV charging. The one or more EV charging stations 201 and the primary system 202 can communicate using, for example, the OCPP.

Herein, any messages transmitted and/or received by any system/device/components may comprise an OCPP message.

The system 200 may further comprise the client device 100. The system 200 may further comprise a second load balancer 220. The second load balancer 220 may forward messages from the client device 100 to the primary EV charging management system 202 when the primary EV charging management system 202 is available. The second load balancer 220 may also forward messages from the primary EV charging management system 202 to the client device 100 when the primary EV charging management system 202 is available. The second load balancer 220 may, for example, implement an application programming interface (API) using which the client device 100 can communicate with the primary system 202.

For example, when a user wishes to start charging using an EV charging station 201, the user can indicate this to the primary system 202 using the client device 100. The primary system 202 can process this request and transmit a command to enable charging to the corresponding EV charging station 201.

The primary system 202 can have quite a complicated technical architecture and logic. A modern CPMS can comprise tens or hundreds of different services, components, data storages, complex business logic, integrations to third party systems etc. For example, in the example of FIG. 2, the primary system 202 comprises various interconnected services and components 203, data storages 204, and integration to third parties 205. In order for the primary system 202 to give a valid reply, such as accepting or rejecting a charging request from an EV charging station 201 all the technical components should be functioning correctly.

Thus, the primary system 202 can have technical issues. When this occurs, it is quite common for a user to not be able to charge using the EV charging station 201 until the issues with the primary system 202 have been resolved.

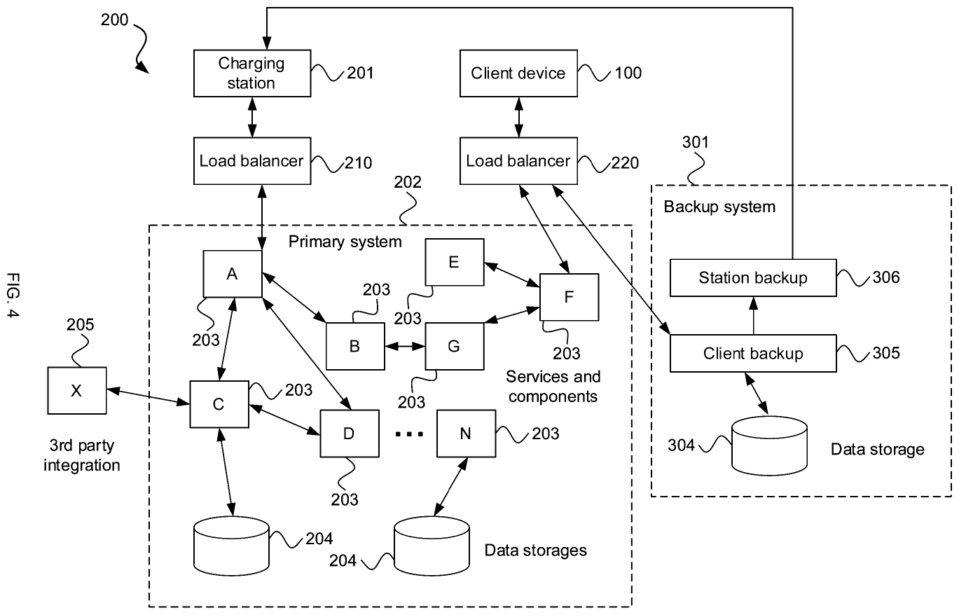

FIG. 3 illustrates a schematic representation of a backup EV charging management device according to an embodiment.

According to an embodiment, a backup EV charging management device 300 comprises at least one processor 310 and at least one memory 320 including computer program code.

According to an embodiment, the at least one memory 320 and the computer program code configured to, with the at least one processor 310, cause the EV charging management device 300 to, when a primary EV charging management system 202 is available, synchronize a data storage of a backup EV charging management system with a data storage of the primary EV charging management system 202, wherein the data storage of the primary EV charging management system comprises identifications of a plurality of EV charging stations.

The data storage may also be referred to as, charge cache or similar. The data storage(s) may comprise any information/data related to the use of the of EV charging stations. For example, the data storage may comprise information about charging events.

Herein, a “charging event” may refer to any event related to EV charging using an EV charging station. For example, a charging event may correspond to a single continuous charge performed by a user. Data/information about a charging event may comprise, for example, a start time of a charging event, an end time of a charging event, energy consumption of a charging event, and/or status of a charging event. A charging event may also be referred to simply as a charge or similar.

The backup EV charging management device 300 may be further configured to, when the primary EV charging management system 202 is unavailable, receive a request for charging using a target EV charging station 201 from a client device 100, wherein the request comprises an identification of the target EV charging station 201.

The backup EV charging management device 300 may be further configured to check whether the request should be allowed by comparing the identification of the target EV charging station and the identifications of a plurality of EV charging stations in the data storage of the backup EV charging management system.

The backup EV charging management device 300 may compare the identification of the target EV charging station and the identifications of a plurality of EV charging stations in the data storage by, for example, checking whether the identification of the target EV charging station is in the identifications of a plurality of EV charging stations. Alternatively or additionally, the identifications of a plurality of EV charging stations may comprise additional information against which the backup EV charging management device 300 can check the identification of the target EV charging station. For example, the data storage may comprise a whitelist of identifications or a blacklist of identifications. Such lists may indicate, for example, which EV charging station are in service and/or out-of-service.

The backup EV charging management device 300 may also receive other information in the request and compare that information and the data storage as disclosed herein. For example, the request may comprise an identification of the user and the data storage may comprise a list of user identifications that should be allowed to use the EV charging stations. The backup EV charging management device 300 may combine any such checks disclosed herein. For example, the backup EV charging management device 300 can check whether the request should be allowed based on EV charging station identification and user identification in the request.

The backup EV charging management device 300 may be further configured to, in response to determining that the request should be allowed, transmit an acceptance message, indicating to accept the use of the target EV charging station, to the target EV charging station 201.

The backup EV charging management device 300 may also be configured to transmit an acceptance message, indicating that the use of the target EV charging station is accepted, to the client device 100.

The acceptance message may comprise any data based on which the target EV charging station can recognize that the use of the target EV charging station should be accepted. The content of the acceptance message can be defined, for example, in a standard/protocol, such as the open charge point protocol (OCPP).

The backup EV charging management device 300 may correspond to any device that is configured to control the backup EV charging management system. Herein, when the backup system is disclosed to perform some functionality, the backup EV charging management device 300 may be configured to perform, at least partially, that functionality.

Since the data storage of the backup system is synchronized with the data storage of the primary system, the backup EV charging management device 300 can check whether the request should be allowed even when the primary system is not available. Thus, users can still use the EV charging stations even when the primary system is unavailable.

The data storage may comprise, for example, a simple whitelist of identifications that should be allowed to charge. Alternatively, the data storage may comprise more complex information/data based on which the backup EV charging management device 300 can check whether the request should be allowed.

The backup EV charging management device 300 may comprise at least one processor 310. The at least one processor 310 may comprise, for example, one or more of various processing devices, such as a co-processor, a microprocessor, a controller, a digital signal processor (DSP), a processing circuitry with or without an accompanying DSP, or various other processing devices including integrated circuits such as, for example, an application specific integrated circuit (ASIC), a field programmable gate array (FPGA), a microcontroller unit (MCU), a hardware accelerator, a special-purpose computer chip, or the like.

The backup EV charging management device 300 may further comprise a memory 320. The memory 320 may be configured to store, for example, computer programs and the like. The memory 320 may comprise one or more volatile memory devices, one or more non-volatile memory devices, and/or a combination of one or more volatile memory devices and non-volatile memory devices. For example, the memory 320 may be embodied as magnetic storage devices (such as hard disk drives, floppy disks, magnetic tapes, etc.), optical magnetic storage devices, and semiconductor memories (such as mask ROM, PROM (programmable ROM), EPROM (erasable PROM), flash ROM, RAM (random access memory), etc.).

When the backup EV charging management device 300 is configured to implement some functionality, some component and/or components of the backup EV charging management device 300, such as the at least one processor 310 and/or the memory 320, may be configured to implement this functionality. Furthermore, when the at least one processor 310 is configured to implement some functionality, this functionality may be implemented using program code comprised, for example, in the memory 320. For example, if the backup EV charging management device 300 is configured to perform an operation, the at least one memory 320 and the computer program code can be configured to, with the at least one processor 310, cause the backup EV charging management device 300 to perform that operation.

In some embodiments, the backup EV charging management device 300 may be implemented as and/or as a part of a cloud computing system.

The backup system can have a simple and lightweight structure. Thus, the backup system can be more robust and fault tolerant than the primary system.

The backup system can be compatible with various different EV charging station models. Other solutions may be proprietary and EV charging station model-specific.

The backup system can ensure that only authorized people can charge using the EV charging stations at least in most cases. Thus, no invalid data is recorded, and no data is lost, which can enable, for example, the correct invoicing of users.

FIG. 4 illustrates a schematic representation of an EV charging system 200 according to an embodiment.

According to an embodiment, an EV charging system 200 comprises a primary EV charging management system 202, a backup EV charging management system 301 comprising a backup EV charging management device 300, at least one EV charging station 201, and a first load balancer 210 configured to forward messages from the at least one EV charging station 201 to the primary EV charging management system 202 when the primary EV charging management system 202 is available and forward messages from the at least one EV charging station 201 to the backup EV charging management system 301 when the primary EV charging management system 202 is unavailable.

The backup system 301 can function as a lightweight, simple backup system that lacks all the complex business logic, integrations, data storages etc. of the primary system 202. Thus, the backup system 301 can be more fault tolerant and low cost.

The backup system 301 can comprise various parts/components/subsystems. For example, the backup system 301 may comprise a first part 305 that is configured to communicate with the client device 100 and can perform actions related to the communication with the client device 100. This part may be referred to as client backup system or app backup system.

The backup system 301 may further comprise a second part 306 that is configured to communicate with the at least one EV charging station 201 and can perform actions related to the communication with the at least one EV charging station 201. This can comprise, for example, the capability to process critical OCPP messages, such as heartbeats, boot notifications, authentication, start- and stop-messages, even when the primary system 202 is offline. This part may be referred to as a station backup system.

The functionality of these parts/components/subsystems may be performed by, for example, the backup EV charging management device 300 and/or a plurality of different devices.

In the case of major issues with the primary system 202, all OCPP traffic from EV charging stations 201 can be directed to the backup system 301 by, for example, the first load balancer 210 and the second load balancer 220. The backup system 301 can then, for example, process few key OCPP messages from the EV charging stations 201 and client devices 100, transmit replies back to the EV charging stations 201 and client devices 100 based on limited simple logic, and allowing users to still charge using the EV charging stations 201.

Any devices/systems/components/modules disclosed herein may communicate with each other using, for example, a data connection. The data connection may be any connection that enables devices/systems/components/modules to communicate with each other. The data connection may comprise, for example, internet, Ethernet, 3G, 4G, 5G, long-term evolution (LTE), new radio (NR), Wi-Fi, or any other wired or wireless connections or some combination of these. For example, the data connection may comprise a wireless connection, such as Wi-Fi, an internet connection, and an Ethernet connection.

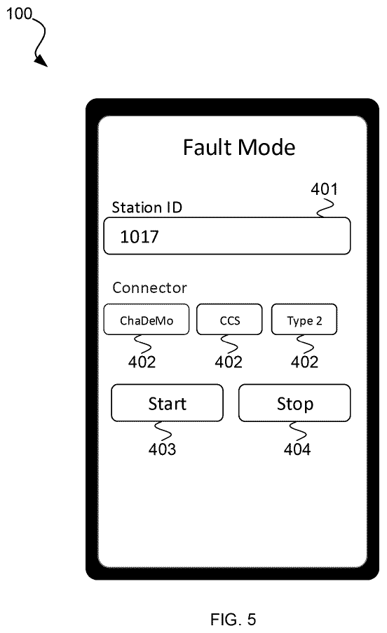

FIG. 5 illustrates a schematic representation of a user interface of a client device 100 according to an embodiment.

The user of a the client device 100 can interact with the client device 100 via a user interface (UI). The UI may be implemented in the client device 100 via, for example, a mobile application, also referred to as an app. The client device 100 may comprise, for example, a touch screen via which the user can provide input to the client device 100.

The UI may comprise an EV charging station identification (ID) 401. A user can, for example, type in the station ID 401, choose the ID 401 from a list, and/or the ID may be selected automatically based on the location of the client device 100. The ID 401 may be presented to the user via, for example, a sticker on the EV charging station 201.

If the EV charging station 201 has a plurality different types of connectors for connecting the EV charging station to an EV, the UI can present a selector 402 for the user to select which connector the user wishes to use for charging. Based on the selection made by the user, the client device 100 may include the information about the selected connector into the request for charging.

According to an embodiment, the data storage of the primary EV management system further comprises information about available connectors in each EV charging station in the plurality of EV charging station and wherein the request further comprises an indication of a connector the user wishes to use in the target EV charging station. The backup electric vehicle charging management device 300 may be further configured to check whether the request should be allowed by comparing the indication of a connector the user wishes to use and information about available connectors in each EV charging station in the plurality of EV charging station in the data storage of the backup EV charging management system.

The information about available connectors in each EV charging station may, for example, indicate which types of connectors are available in each EV charging station and/or which connectors are in service. The backup electric vehicle charging management device 300 may the check whether the request should be allowed by checking whether the connecter requested by the client device is available and/or in service.

The UI can further provide virtual buttons or similar to the user for starting 403 and/or stopping 404 the charging. The client device 100 may, for example, send the request for charging when the user presses the start button 403. Similarly, the client device 100 can send a request to stop charging when the user presses the stop button 404.

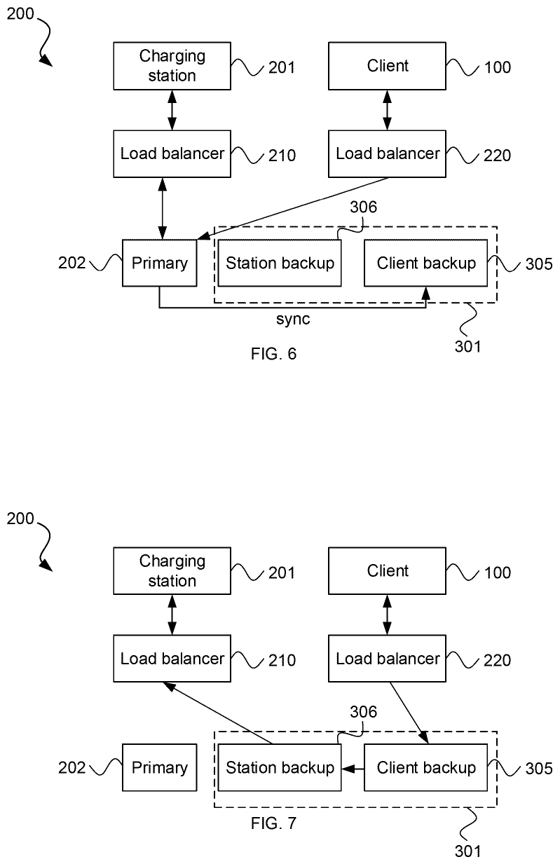

FIG. 6 illustrates a schematic representation of functionality of the EV charging system when the primary system is available according to an embodiment.

According to an embodiment, the client device 100 is preconfigured with an application programming interface (API) uniform resource locator (URL) for the primary EV charging management system 202 and an API URL for the backup EV charging management system 301, and the client device 100 is further configured to transmit the request for EV charging using the EV charging station 201 to the primary EV charging management system 202 based on the API URL of primary the EV charging management system 202 and to transmit the request for EV charging using the EV charging station to the backup EV charging management system 301 based on the API URL of the backup EV charging management system 301.

The client device 100 may be configured with two API URLs. A first URL for the primary system 202 can be used during normal operations and a second URL for the app backup system 301 can be used if main URL is not responding. During normal operation, when the main URL is available in the CPMS, the client device 100 can use the first URL for API calls.

Herein, “configured with” may indicate that the API URLs are stored in the client device 100, for example, in the memory 102 of the client device 100 and the client device 100 is configured to switch from using the API URL of the primary system 202 to using the API URL of the backup system 301 in a manner disclose herein.

Some data may be synchronized from the primary system 202 to the app backup system 301 when the primary system 202 is available. The app backup system 301 can then utilise the synchronized data when the primary system 202 is unavailable. The data may comprise EV charging station 201 identifications (IDs) and connectors available at each EV charging station 201. The data may further comprise user IDs, such as idTags, so that the app backup system 301 can identify users. The data may further comprise information about ongoing charging events, such as transaction IDs of charging events so that the app backup system 301 can stop the charging events at an appropriate time.

According to an embodiment, the data storage of the primary EV management system further comprises a plurality of user identifications and the request further comprises a user identification. The backup EV charging management device 300 may be further configured to check whether the request should be allowed by comparing the user identification in the request to the plurality of user identifications in the data storage of the backup EV charging management system.

The data storage may comprise, for example, a simple whitelist of user identifications indicating which users should be allowed to perform charging. Alternatively, the data storage may comprise more complex information/data based on which the backup EV charging management device 300 can check whether the request should be allowed.

According to an embodiment, the data storage of the primary EV management system further comprises identifications of ongoing charging events. The backup EV charging management device 300 may be further configured to, in response to receiving a request to stop charging comprising a charging event identification, check whether the request to stop charging should be allowed by comparing the identification in the request to the identifications of ongoing charging events in the data storage of the backup EV charging management system. The backup EV charging management device 300 may be further configured to, in response to determining that the request to stop charging should be allowed, send a charging stop command to an EV charging station corresponding to the charging event identification in the request.

In normal situations, when the primary system 202 is available, all traffic from the EV charging stations 201 and from the client devices 100 can be directed to the primary system 202. The primary system 202 can then handle the traffic in a normal fashion, following the normal logic of the primary system 202.

FIG. 7 illustrates a schematic representation of functionality of the EV charging system when the primary system is unavailable according to an embodiment.

According to an embodiment, the client device is further configured to, in response to the primary EV charging management system 202 not responding to the request for EV charging using the EV charging station, transition into a fault mode and, when in the fault mode, in response to a further input from a user of the client device, wherein the further input indicates that the user wishes to stop the EV charging using an EV charging station, transmit a request to stop the EV charging using the EV charging station to the backup EV charging management system 301.

If the URL of the primary system 202 stops responding, the client device 100 knows that the primary system 202 is not available. Thus, the client device 100 can automatically switch itself to a so-called fault mode. When in the fault mode, the client device 100 can use the API URL of the secondary backup system 301 for all API calls. The client device 100 may remain in the fault mode until the primary system 202 is again available.

According to an embodiment, the request for EV charging using the EV charging station further comprises an indication of an electrical connector of the EV charging station the user wishes to use for the charging and/or an identification of the user.

According to an embodiment, the identification of the user comprises an identity token of the user.

When the client device 100 is in the fault mode, it can transmit, for example, station ID and connector type, to the backup system 301. The client device 100 may also transmit identifying information about the user, such as a JavaScript object notation (JSON) web token (JWT).

The backup system 301 can check from the data storage what is the identification, such as idTag, of a user with the given identification token, such as JWT.

The backup system 301 can also check from the data storage other information needed by the OCPP protocol. This may comprise, for example, technical identity for the EV charging station and a connector number for the selected connector.

The backup system can also send this information (identity, connector number, idTag) to the station backup system 306, which can transform the data into an OCPP command. The OCPP command can be transmitted to the EV charging station 201 in order to start charging. The station backup system 306 can also return an individual transaction ID for the charging event, which can be used to identify, and later stop, the charging event.

The backup system 301 can also store data about charging events into the data storage. The data can comprise, for example, the idTag of the user, so that the backup system 301 can keep track of which user started charging and when.

When the client device 100 is in the fault mode and a user wishes to stop charging using the EV charging station 201, the client device 100 can send, for example, station ID and connector information to the backup system 301. The client device 100 may also transmit identifying information about the user, such as a JWT.

The backup system 301 can then check from the local data storage if the user has an ongoing charging event with the given EV charging station and connector, and what is the ID of this charging event.

If the charging event is found in the local cache, the backup system 301 can pass this information to the station backup system 306 which can create an OCPP command and transmit the command to the EV charging station 201 which can stop the charging event.

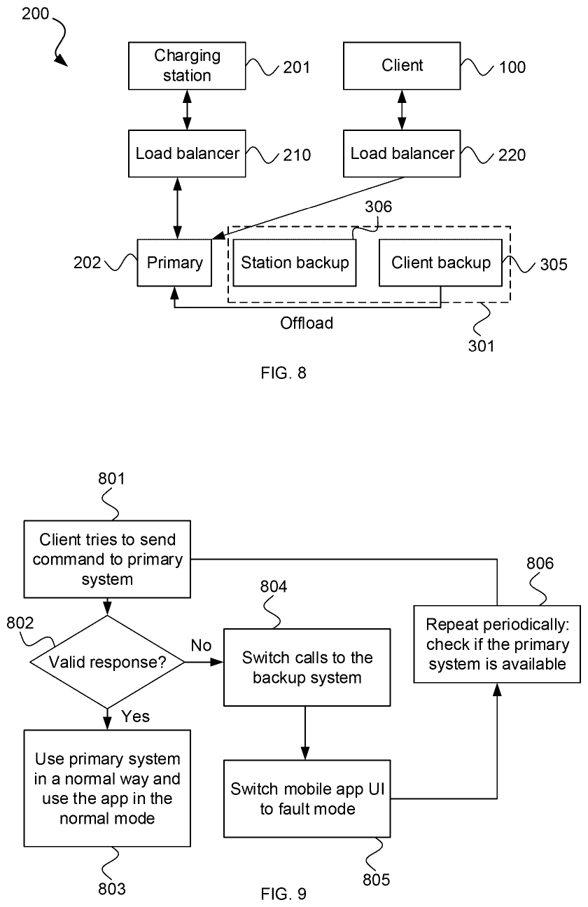

FIG. 8 illustrates a schematic representation of functionality of the EV charging system when the primary system is again available after being unavailable according to an embodiment.

According to an embodiment, the client device 100 is further configured to, when in the fault mode, to periodically check whether the primary EV charging management system 202 is available. The client device 100 may, for example, periodically transmit API calls to the primary system 202 in order to check whether the primary EV charging management system 202 is available.

According to an embodiment, the backup EV charging management device 300 is further configured to, when the primary EV charging management system is unavailable, store information about charging events into the data storage of the backup EV management system and, in response to the primary EV charging management system 202 becoming available, provide the information about the charging events to the primary EV charging management system. This providing the information to the primary system 202 may also be referred to as offloading.

According to an embodiment, the information about charging events occurred during the primary EV charging management system being unavailable comprises at least one of: indication that a charging event, that started when the primary EV management system was available, ended when the primary EV management system was unavailable; indication that a new charging event has started when the primary EV charging management system was unavailable and is ongoing when the primary EV charging management system is again available; and/or indication that a new charging event has started and ended when the primary EV charging management system was unavailable.

The backup EV charging management device 300 may store the information about charging events in various ways. For example, if a charging event that started when the primary EV management system 202 was available ended when the primary EV management system 202 was unavailable, the backup EV charging management device 300 can store the end time of the charging event into a record corresponding to the charging event. The backup EV charging management device 300 can then provide the updated record to the primary system 202 when the primary system 202 is again available, and the primary system 202 can detect the change in the record. On the other hand, if a new charging event has started when the primary EV management system 202 was unavailable, the backup EV charging management device 300 generate a new record corresponding to the new charging event and store a start time, and possibly other information such as an end time if the charging event also ended when the primary system was unavailable, into the new record. The backup EV charging management device 300 can then provide the new record to the primary system 202 when the primary system 202 is again available, and the primary system 202 can detect that the record is new.

During the fault mode, the client device 100 can check periodically, such as once a minute, if the primary system 202 is available again. Once the primary system 202 responds normally to API commands/calls, the client device 100 can switch back to normal mode. In normal mode, the client device 100 can transmit messages/API calls to the primary system 202 by default.

The app backup system 301 can also check periodically, such as once a minute, if the primary system 202 is available again. After the primary system 202 is available, the offloading process can begin.

First, the station backup system 306 can perform an offloading procedure which transmits OCPP messages to the primary system 202.

After the station backup system 306 has finished offloading, the app backup system 301 can start offloading charging event data from the local data storage to the primary system 202.

The primary system 202 can check if a charging event with the given transaction ID that the app backup system 301 offloads already exists in the primary system 202. If it does, the primary system 202 can check if the app backup system's charging event comprises newer information. If yes, the primary system 202 can update its own information. If the charging event does not yet exist in the primary system 202, the primary system 202 can create it based on the data from the app backup system 301.

FIG. 9 illustrates a flow chart representation of a client mode switching procedure according to an embodiment.

In operation 801, the client device 100 can try to send a command to the primary system 202.

In operation 802, the client device 100 can check whether the primary system 202 responds with a valid response. If the primary system 202 responds with a valid response, the client device 100 can move to operation 803. In operation 803, the client device 100 can continue to operate in the normal mode and continue to use the primary system 202.

If the primary system 202 does not respond with a valid response, the client device 100 can move to operation 804. In operation 804, the client device 100 can switch future calls to the backup system 301.

In operation 805, the client device 100 can switch the UI of the mobile application to the fault mode. An example embodiment of a fault mode UI is illustrated in the embodiment of FIG. 5. The fault mode UI can have a limited functionality.

In operation 806, the client device can check periodically, such as one a minute, whether the primary system 202 is available. Once the primary system 202 is available, the client device 100 can transition back to operation 801.

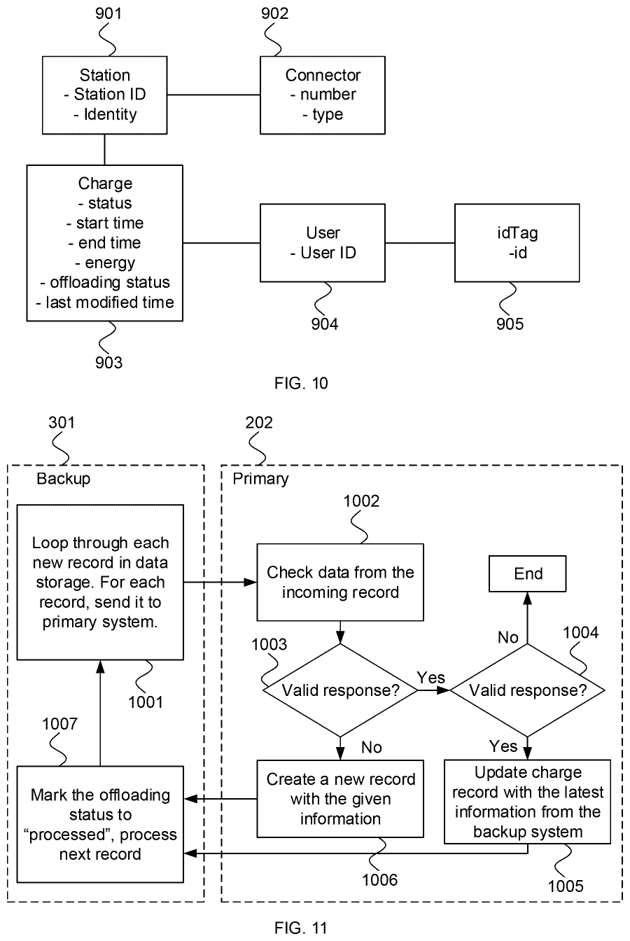

FIG. 10 illustrates a schematic representation of a data storage structure according to an embodiment.

The backup system 301 can store at least some of the data illustrated in the embodiment of FIG. 10 in the data storage.

The data storage structure may comprise EV charging station data 901. The EV charging station data 901 can comprise, for example, a station ID and an identity.

The data storage structure may further comprise EV charging connector data 902. The EV charging connector data 902 may comprise, for example, a number of connectors and types of connectors in each EV charging station 201.

The data storage structure may further comprise charge event data 903. The charge event data 903 may comprise, for example, status of a charge event, a start time of a charge event, end time of a charge event, energy consumption of a charge event, offloading status of a charge event, and/or last modified time of a charge event.

The data storage structure may further comprise user data 904, such as a user ID.

The data storage structure may further comprise idTag data 905.

The different data in the data storage structure may be associated with each other. For example, station data 901 may be associated with connector data 902 when the connector data related to connectors of an EV charging station corresponding to the station data 901. Similarly, the charging event data may be associated with the station data 901, user data may be associated with charging event data 903, and idTag data 905 may be associated with user data 904.

FIG. 11 illustrates a flow chart representation of a data offloading procedure according to an embodiment.

The procedure may start when the primary system 202 is again available after being unavailable and the backup system 301 has been in use.

In operation 1001, the backup system can loop through each new record in the data storage that has not been sent to the primary system. A record may correspond to, for example, any record related to a charging event, such as start or stop. The backup system 301 can send each such record to the primary system.

In operation 1002, the primary system can check each record received from the backup system 301.

In operation 1003, the primary system 202 can check whether a transaction ID already exists in the primary system for the received record. If the transaction ID does not exist, the primary system 202 can move to operation 1006 and create a new record with the received information.

If the transaction ID does exist, the primary system can move to operation 1004 to check whether the received data is newer than corresponding data in the primary system. For example, the primary system can check whether the “last modified” timestamp is newer in the received data than in the primary system. If the received data is not newer than corresponding data in the primary system, the primary system can stop the procedure with respect to that specific received data. Otherwise, the primary system can move to operation 1005 and update the record with the latest information from the backup system 301.

From operations 1006 and 1005, the primary system 202 can transmit an indication to the backup system 301 that the data has been stored. In response to receiving the indication, the backup system 301 can perform operation 1007 can mark the data as offloaded and proceed to process the next record. The procedure can repeat for the next record from operation 1001.

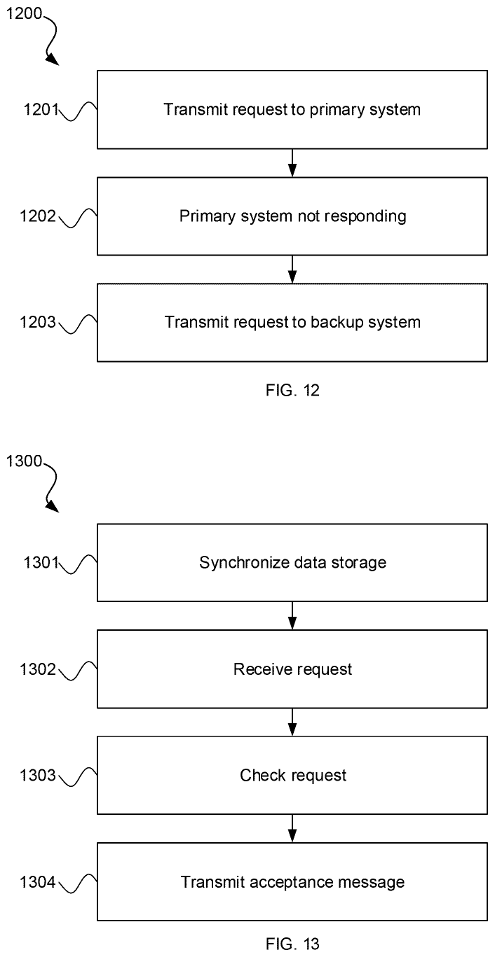

FIG. 12 illustrates a schematic representation of a method 1200 according to an embodiment.

According to an embodiment, the method 1200 comprises, in response to an input from a user of a client device, wherein the input indicates that the user wishes to charge an electric vehicle, EV, using an EV charging station, transmitting 1201 a request for EV charging using the EV charging station to a primary EV charging management system, wherein the request for EV charging using the EV charging station comprises an identification of the EV charging station.

The method 1200 may further comprise, in response to the primary EV charging management system not responding 1202 to the request for EV charging using the EV charging station, transmitting 1203 the request for EV charging using the EV charging station to a backup EV charging management system.

The method 1200 may be performed by the client device 100 of FIG. 1. Further features of the method 1200 directly result from the functionalities and parameters of the backup client device 100. The method 1200 can be performed, at least partially, by computer program(s).

FIG. 13 illustrates a schematic representation of a method 1300 according to an embodiment.

According to an embodiment, the method 1300 comprises, when a primary electric vehicle, EV, charging management system is available, synchronizing 1301 a data storage of a backup EV charging management system with a data storage of the primary EV charging management system, wherein the data storage of the primary EV charging management system comprises identifications of a plurality of EV charging stations.

The method 1300 may further comprise, when the primary EV charging management system is unavailable, receiving 1302 a request for charging using a target EV charging station from a client device, wherein the request comprises an identification of the target EV charging station.

The method 1300 may further comprise, checking 1303 whether the request should be allowed by comparing the identification of the target EV charging station and the identifications of a plurality of EV charging stations in the data storage of the backup EV charging management system.

The method 1300 may further comprise, in response to determining that the request should be allowed, transmitting 1304 an acceptance message, indicating to accept the use of the target EV charging station, to the target EV charging station.

The method 1300 may be performed by the backup EV charging management device 300 of FIG. 3. Further features of the method 1300 directly result from the functionalities and parameters of the backup EV charging management device 300. The method 1300 can be performed, at least partially, by computer program(s).

In at least some embodiments, the backup system can function with client devices using mobile applications even if the primary system is offline. Thus, customers can continue charging, possibly in a limited way, even if the primary system is unavailable.

In at least some embodiments, the backup system can offload relevant charging event information to the primary system. Thus, no data is lost, and full information of all charging events can be obtained.

At least some embodiments work with mobile applications.

At least some embodiments can function with various EV charging station models with high flexibility and compatibility.

An apparatus may comprise means for performing any aspect of the method(s) described herein. According to an embodiment, the means comprises at least one processor, and memory comprising program code, the at least one processor, and program code configured to, when executed by the at least one processor, cause performance of any aspect of the method.

Any range or device value given herein may be extended or altered without losing the effect sought. Also any embodiment may be combined with another embodiment unless explicitly disallowed.

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims and other equivalent features and acts are intended to be within the scope of the claims.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item may refer to one or more of those items.

The steps of the methods described herein may be carried out in any suitable order, or simultaneously where appropriate. Additionally, individual blocks may be deleted from any of the methods without departing from the spirit and scope of the subject matter described herein. Aspects of any of the embodiments described above may be combined with aspects of any of the other embodiments described to form further embodiments without losing the effect sought.

The term ‘comprising’ is used herein to mean including the method, blocks or elements identified, but that such blocks or elements do not comprise an exclusive list and a method or apparatus may contain additional blocks or elements.

It will be understood that the above description is given by way of example only and that various modifications may be made by those skilled in the art. The above specification, examples and data provide a complete description of the structure and use of exemplary embodiments. Although various embodiments have been described above with a certain degree of particularity, or with reference to one or more individual embodiments, those skilled in the art could make numerous alterations to the disclosed embodiments without departing from the spirit or scope of this specification.

1. A client device, comprising:
at least one processor; and
at least one memory including computer program code;
the at least one memory and the computer program code configured to, with the at least one processor, cause the client device (100) to:
in response to an input from a user of the client device, wherein the input indicates that the user wishes to charge an electric vehicle, EV, using an EV charging station, transmit a request for EV charging using the EV charging station to a primary EV charging management system, wherein the request for EV charging using the EV charging station comprises an identification of the EV charging station; and
in response to the primary EV charging management system not responding to the request for EV charging using the EV charging station, transmit the request for EV charging using the EV charging station to a backup EV charging management system.

2. The client device according to claim 1, wherein the client device is preconfigured with an application programming interface, API, uniform resource locator, URL, for the primary EV charging management system and an API URL for the backup EV charging management system, and the at least one memory and the computer program code are further configured to, with the at least one processor, cause the client device to transmit the request for EV charging using the EV charging station to the primary EV charging management system based on the API URL of the primary EV charging management system and to transmit the request for EV charging using the EV charging station to the backup EV charging management system based on the API URL of the backup EV charging management system.

3. The client device according to claim 1, wherein the request for EV charging using the EV charging station further comprises:
an indication of an electrical connector of the EV charging station the user wishes to use for the charging; and/or
an identification of the user.

4. The client device according to claim 3, wherein the identification of the user comprises an identity token of the user.

5. The client device according to claim 1, wherein the at least one memory and the computer program code are further configured to, with the at least one processor, cause the client device to:
in response to the primary EV charging management system not responding to the request for EV charging using the EV charging station, transition into a fault mode; and
when in the fault mode, in response to a further input from a user of the client device, wherein the further input indicates that the user wishes to stop the EV charging using an EV charging station, transmit a request to stop the EV charging using the EV charging station to the backup EV charging management system.

6. The client device according to claim 5, wherein the at least one memory and the computer program code are further configured to, with the at least one processor, cause the client device, when in the fault mode, to periodically check whether the primary EV charging management system is available.

7. A backup electric vehicle, EV, charging management device, comprising:
at least one processor; and
at least one memory including computer program code;
the at least one memory (320) and the computer program code configured to, with the at least one processor, cause the backup EV charging management device to:
when a primary EV charging management system is available, synchronize a data storage of a backup EV charging management system with a data storage of the primary EV charging management system, wherein the data storage of the primary EV charging management system comprises identifications of a plurality of EV charging stations;
when the primary EV charging management system is unavailable, receive a request for charging using a target EV charging station from a client device, wherein the request comprises an identification of the target EV charging station;
check whether the request should be allowed by comparing the identification of the target EV charging station and the identifications of a plurality of EV charging stations in the data storage of the backup EV charging management system; and
in response to determining that the request should be allowed, transmit an acceptance message, indicating to accept the use of the target EV charging station, to the target EV charging station.

8. The backup EV charging management device, according to claim 7, wherein the data storage of the primary EV management system further comprises information about available connectors in each EV charging station in the plurality of EV charging stations and wherein the request further comprises an indication of a connector the user wishes to use in the target EV charging station, and wherein the at least one memory and the computer program code are further configured to, with the at least one processor, cause the backup EV charging management device to:
check whether the request should be allowed by comparing the indication of a connector the user wishes to use and information about available connectors in each EV charging station in the plurality of EV charging stations in the data storage of the backup EV charging management system.

9. The backup EV charging management device, according to claim 7, wherein the data storage of the primary EV management system further comprises a plurality of user identifications and wherein the request further comprises a user identification, and wherein the at least one memory and the computer program code are further configured to, with the at least one processor, cause the backup EV charging management device to:
check whether the request should be allowed by comparing the user identification in the request to the plurality of user identifications in the data storage of the backup EV charging management system.

10. The backup EV charging management device, according to claim 7, wherein the data storage of the primary EV management system further comprises identifications of ongoing charging events and wherein the at least one memory and the computer program code are further configured to, with the at least one processor, cause the backup EV charging management device to:
in response to receiving a request to stop charging comprising a charging event identification, check whether the request to stop charging should be allowed by comparing the identification in the request to the identifications of ongoing charging events in the data storage of the backup EV charging management system; and
in response to determining that the request to stop charging should be allowed, send a charging event stop command to an EV charging station corresponding to the charging event identification in the request.

11. The backup EV charging management device according to claim 7, wherein the at least one memory and the computer program code are further configured to, with the at least one processor, cause the backup EV charging management device to:
when the primary EV charging management system is unavailable, store information about charging events into the data storage of the backup EV management system; and
in response to the primary EV charging management system becoming available, provide the stored information about the charging events to the primary EV charging management system.

12. The backup EV charging management device according to claim 11, wherein the information about charging events comprises at least one of:
indication that a charging event that started when the primary EV management system was available, ended when the primary EV management system was unavailable;
indication that a new charging event has started when the primary EV charging management system was unavailable and is ongoing when the primary EV charging management system is again available; and/or
indication that a new charging event has started and ended when the primary EV charging management system was unavailable.

13. A method, comprising:
in response to an input from a user of a client device, wherein the input indicates that the user wishes to charge an electric vehicle, EV, using an EV charging station, transmitting a request for EV charging using the EV charging station to a primary EV charging management system, wherein the request for EV charging using the EV charging station comprises an identification of the EV charging station; and
in response to the primary EV charging management system not responding to the request for EV charging using the EV charging station, transmitting the request for EV charging using the EV charging station to a backup EV charging management system.

14. A method, comprising:
when a primary electric vehicle, EV, charging management system is available, synchronizing a data storage of a backup EV charging management system with a data storage of the primary EV charging management system, wherein the data storage of the primary EV charging management system comprises identifications of a plurality of EV charging stations;
when the primary EV charging management system is unavailable, receiving a request for charging using a target EV charging station from a client device, wherein the request comprises an identification of the target EV charging station;
checking whether the request should be allowed by comparing the identification of the target EV charging station and the identifications of a plurality of EV charging stations in the data storage of the backup EV charging management system; and
in response to determining that the request should be allowed, transmitting an acceptance message, indicating to accept the use of the target EV charging station, to the target EV charging station.

15. A computer program product comprising program code configured to perform the method according to claim 13 when the computer program product is executed on a computer.
